(19) United States
(12) Patent Application Publication
(10) Pub. No.: US 2026/0369294 A1
(43) Pub. Date: Nov. 19, 2026

(54) HEAD RELATED TRANSFER FUNCTION APPLICATION TO SOUND LOCATION IN EMERGENCY SCENARIOS

(71) Applicant: 3M INNOVATIVE PROPERTIES COMPANY, St. Paul, MN (US)

(72) Inventors: Richard J. Sabacinski, Charlotte, NC (US); Traian Morar, Matthews, NC (US); Darin K. Thompson, Huntersville, MN (US); Andrew A. S. Cox, Indian Trail, NC (US); Kevin A. Chaney, Albemarle, NC (US)

(21) Appl. No.: 19/132,253

(22) PCT Filed: Nov. 21, 2023
(86) PCT No.: PCT/IB2023/061747

§ 371 Date: May 22, 2025

Related U.S. Application Data
(60) Provisional application No. 63/429,012, filed on Nov. 30, 2022.

(51) Int. Cl. G10L 25/30; G06T 19/00; G06V 40/18; G08B 25/01; H04S 7/00

(52) U.S. Cl. CPC G10L 25/30; G06T 19/006; G06V 40/18; G08B 25/016; H04S 7/303; H04S 2420/01

(57) ABSTRACT

A head worn device configured to be worn by a user is provided. The head worn device includes at least one microphone, at least one image sensor, and processing circuitry configured to receive an audio signal detected by the at least one microphone, the audio signal originating from a signal source. The processing circuitry is configured to determine a location of the signal source based on the received audio signal. The processing circuitry is further configured to receive image data from the at least one image sensor, the image data being associated with at least one of the user's face and at least one of the user's eyes. The processing circuitry is further configured to determine a gaze direction of the user based on the received image data, and determine a user instruction based on the determined location and determined gaze direction.

### TECHNICAL FIELD

This disclosure relates to location detection, and in particular to an apparatus and system, and related methods of use thereof, for directing a first responder to the source of a signal in a limited visibility emergency environment.

### Introduction

Visibility of target items or individuals being sought may be obscured in emergency situations and environments. This obscuration may be caused by smoke, suspended matter, piles of debris, low or no light, etc., or the target may be covered with a dusting of ash, dirt, soot, etc., making rapid recognition impossible. Similarly, in an industrial environment, an individual could be partially hidden by machinery, electrical wiring and equipment, pipes and pipe racks, etc. First responders may be unable to identify the origin/location of a signal source (such as a sound generating source and/or radio beacon/signal) in such a limited visibility environment.

### SUMMARY

A head worn device, such as a face mask, goggles, and/or self-contained breathing apparatus (SCBA), may use image sensors and/or audio sensors to accurately identify the source of a sound, such as a sound emitted by a person-down alarm in an emergency environment, and to determine the gaze of the user of the head worn device. The head worn device may include a user interface configured to indicate the signal source location to the user of the head worn device and direct the user to the location based on the determined gaze.

Some embodiments advantageously provide a method and system for a head worn device configured to be worn by a user. In some embodiments, the head worn device includes at least one microphone, at least one image sensor, and processing circuitry configured to receive an audio signal detected by the at least one microphone, the audio signal originating from a signal source. The processing circuitry is configured to determine a location of the signal source based on the received audio signal. The processing circuitry is further configured to receive image data from the at least one image sensor, the image data being associated with at least one of the user's face and at least one of the user's eyes. The processing circuitry is further configured to determine a gaze direction of the user based on the received image data, and determine a user instruction based on the determined location and determined gaze direction.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a schematic diagram of various devices and components according to some embodiments of the present invention;

FIG. 2 is a block diagram of an example head worn device according to some embodiments of the present invention;

FIG. 3 is a block diagram of an example hand held device according to some embodiments of the present invention;

FIG. 4 is an illustration of a technique for sound location using a head worn device, according to some embodiments of the present invention;

FIG. 5 is an illustration of a technique for gaze tracking using a head worn device, according to some embodiments of the present invention;

FIG. 6 is an illustration of another technique for gaze tracking using a head worn device, according to some embodiments of the present invention;

FIG. 7 is an illustration of another technique for gaze tracking using a head worn device, according to some embodiments of the present invention;

FIG. 8 is an illustration of another technique gaze tracking using a head worn device, according to some embodiments of the present invention;

FIG. 9 is an illustration of another technique for sound location using a head worn device, according to some embodiments of the present invention;

FIG. 10 is an illustration of another technique for sound location using a head worn device, according to some embodiments of the present invention

FIG. 11 is an illustration of another technique for sound location using a head worn device, according to some embodiments of the present invention; and

FIG. 12 is a flowchart of an example process in a head worn device according to some embodiments of the present invention.

### DETAILED DESCRIPTION

Before describing in detail exemplary embodiments, it is noted that the embodiments reside primarily in combinations of apparatus components and processing steps related to signal source location and gaze tracking for a first responder. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In embodiments described herein, the term “signal source” may be any detectable signal, which may, for example, indicate and/or be associated with a distress state of a person (such as a first responder) and/or a device (such as a hand held alarm device). For example, a signal source may include an audible sound, such as an alarm sound emitted by a personal alarm device, which may include a piercing (e.g., high frequency) sound and/or a low frequency sound. A signal source may include sounds associated with an emergency/life threatening situation, such as sounds generated by a person in distress, by equipment/machinery, by running water, by an explosion, etc. A signal source may also/alternatively include a radio signal/beacon, such as a distress radio signal emitted by a personal alarm device. Other detectable signal types may be employed without deviating from the scope of the present disclosure.

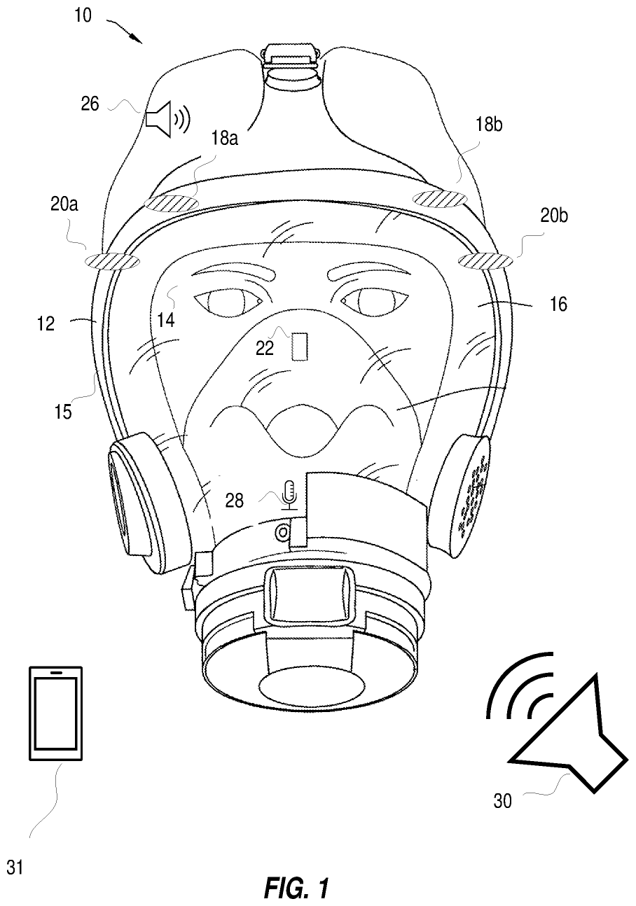

Referring now to the drawing figures, in which like reference designators refer to like elements, FIG. 1 shows an embodiment of a signal source location detection system 10 which utilizes a head worn device 12 worn by user 14, which may include a mask body 15, lens 16, top microphones 18a-b (collectively referred to as “microphones 18”), which may be molded into the head worn device 12, e.g., around the perimeter of a top portion of the lens 16, and side microphones 20a-b (collectively referred to as “microphones 20”), which may be molded into the head worn device 12, e.g., around side portions of the perimeter of lens 16. Head worn device 12 may include a display 22, e.g., integrated into lens 16, for providing visual indications/messages to user 14 of head worn device 12. Head worn device 12 may include speaker 26, e.g., integrated into head worn device 12, for providing audio indications/messages to user 14, and may include user microphone 28, e.g., integrated into head worn device 12, for receiving spoken commands from user 14. Microphones 18 and/or microphones 20 may be configured to detect audio signals, e.g., sound originating from signal source 30, which may be a sound-generating object/entity/event (e.g., wood breaking, a person shouting/breathing, a pressurized gas release (e.g., a jet release), etc.) in the environment/vicinity of a user 14 of head worn device 12. Signal source location detection system 10 may include hand held device 31, which may be in communication with head worn device 12, e.g., via a wired/wireless connection. In some embodiments, head worn device 12 may be a mask, such as a mask that is part of a respirator.

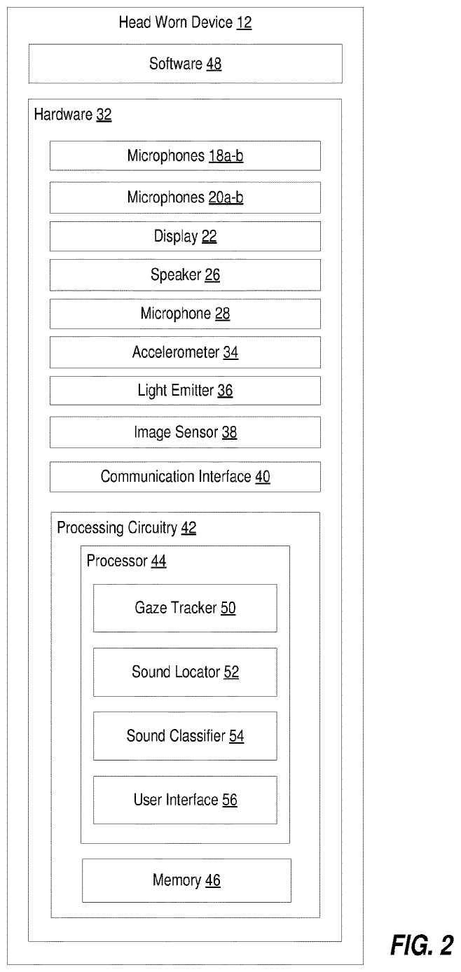

Referring now to FIG. 2, head worn device 12 may include hardware 32, including microphones 18, microphones 20, display 22, speaker 26, microphone 28, accelerometer 34, light emitter 36, image sensor 38, communication interface 40, and processing circuitry 42. The processing circuitry 42 may include a processor 44 and a memory 46. In addition to, or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) the memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Hardware 32 may be removable from the mask body 15 to allow for replacement, upgrade, etc., or may be integrated as part of the head worn device 12.

Head worn device 12 may further include software 48 stored internally in, for example, memory 46 or stored in external memory (e.g., database, storage array, network storage device, etc.) accessible by head worn device 12 via an external connection. The software 48 may be executable by the processing circuitry 42. The processing circuitry 42 may be configured to control any of the methods and/or processes described herein and/or to cause such methods, and/or processes to be performed, e.g., by head worn device 12. Processor 44 corresponds to one or more processors 44 for performing head worn device 12 functions described herein. The memory 46 is configured to store data, programmatic software code and/or other information described herein. In some embodiments, the software 48 may include instructions that, when executed by the processor 44 and/or processing circuitry 42, causes the processor 44 and/or processing circuitry 42 to perform the processes described herein with respect to head worn device 12. For example, head worn device 12 may include gaze tracker 50 configured to perform one or more head worn device 12 functions as described herein, such as detecting the point of gaze (i.e., where user 14 is looking), tracking the 3-dimensional line of sight of user 14, tracking the movement of user 14's eyes, user 14's face, etc., as described herein. Processing circuitry 42 of the head worn device 12 may include sound locator 52 configured to perform one or more head worn device 12 functions as described herein such as determining the location/origin of a signal source 30, as described herein. Processing circuitry 42 of head worn device 12 may include sound classifier 54 configured to perform one or more head worn device 12 functions as described herein such as classifying, labeling, and/or identifying the cause/type of signal source 30, as described herein. Processing circuitry 42 of head worn device 12 may include user interface 56 configured to perform one or more head worn device 12 functions as described herein such as displaying (e.g., using display 22) or announcing (e.g., using speaker 26) indications/messages to user 14, such as indications regarding the location of signal source 30 and/or indications regarding the distance/direction of signal source 30 relative to user 14; and/or receiving spoken commands from user 14 (e.g., using microphone 28) and/or receiving other commands from user 14 (e.g., user 14 presses a button in communication with the processing circuitry 42, user 14 interacts with a separate device, such as a smartphone or hand held device 31, which communicates the user's interactions to the processing circuitry 42 via communication interface 40, etc.) or from other users (e.g., via a remote server which communicates with the processing circuitry 42 via communication interface 40), as described herein.

Although FIG. 1 shows two each of microphones 18 and 20, it is understood that implementations are not limited to two sets of two microphones, and that there can be different numbers of sets of microphones, each having different quantities of individual microphones.

Display 22 may be implemented by any device, either standalone or part of head worn device 12, that is configurable for displaying indications/messages to user 14, e.g., indications regarding the location of signal source 30 and/or indications regarding the distance/direction of signal source 30 relative to user 14. In some embodiments, display 22 may be configured to display an icon (e.g., an arrow), the icon indicating which direction the user should adjust his gaze to, e.g., as determined by sound locator 52 and/or gaze tracker 50. In some embodiments, display 22 may be configured to display a relative distance (e.g., “5 meters”) separating the user from the signal source 30, e.g., as determined by sound locator 52 and/or gaze tracker 50. In some embodiments, display 22 may be configured to display a predicted classification/type/label/etc. of signal source 30, e.g., as determined by sound classifier 54. In some embodiments, display 22 may be configured to display an indication of a location of signal source 30, e.g., as an AR overlay on lens 16, such as by drawing a circle as an augmented reality (AR) overlay on the area of the lens 16 and/or display 22 corresponding to the location of signal source 30 within user 14's field of view. In some embodiments, display 22 may be configured to instruct user 14 to change direction (e.g., turn left, turn right, look up, look down, turn around, etc.) if the location of signal source 30 is outside of user 14's field of view.

Speaker 26 may be implemented by any device, either standalone or part of head worn device 12, that is configurable for generating sound that is audible to user 14 while wearing head worn device 12, and is configurable for announcing (e.g., using speaker 26) indications/messages to user 14, such as indications regarding the location of signal source 30 and/or indications regarding the distance/direction of signal source 30 relative to user 14. In some embodiments, speaker 26 is configured to provide audio messages corresponding to the indications described above with respect to display 22.

Microphone 28 may be implemented by any device, either standalone or part of head worn device 12 and/or user interface 56, that is configurable for detecting spoken commands by user 14 while user 14 is wearing head worn device 12.

Accelerometer 34 may be implemented by any device, either standalone or part of head worn device 12, that is configurable for detecting an acceleration of head worn device 12.

Light emitter 36 may be implemented by any device, either standalone or part of head worn device 12, that is configurable for generating light, such as infrared radiation, and directing the generated light into user 14's eyes for detecting the location of the irises/corneas of user 14 and/or detecting the direction of user 14's gaze. The direction, phase, amplitude, frequency, etc., of light emitted by light emitter 36 may be controllable by processing circuitry 42 and/or gaze tracker 50. Light emitter 36 may include multiple light emitters (e.g., co-located and/or mounted at different locations on head worn device 12), or may include a single light emitter.

Image sensor 38 may be implemented by any device, either standalone or part of head worn device 12, that is configurable for detecting images, such as images of user 14's eyes, face, and/or images of the surrounding environment of user 14, such as images of signal source 30. Image sensor 38 may include multiple image sensors (e.g., co-located and/or mounted at different locations on head worn device 12 and/or on other devices/equipment in communication with head worn device 12 via communication interface 40), or may include a single image sensor.

Communication interface 40 may include a radio interface configured to establish and maintain a wireless connection (e.g., with a remote server via a public land mobile network, with a hand-held device, such as a smartphone, etc.). The radio interface may be formed as, or may include, for example, one or more radio frequency, RF transmitters, one or more RF receivers, and/or one or more RF transceivers. Communication interface 40 may include a wired interface configured to set up and maintain a wired connection (e.g., an ethernet connection, universal serial bus connection, etc.). In some embodiments, head worn device 12 may send, via the communication interface 40, sensor readings and/or data (e.g., image data, direction data, etc.) from one or more of microphones 18, microphones 20, display 22, speaker 26, microphone 28, accelerometer 34, light emitter 36, image sensor 38, communication interface 40, and processing circuitry 42 to additional head worn devices 12 (not shown), hand held device 31, and/or remote servers (e.g., an incident command server, not shown).

In some embodiments, the microphones 18 and 20 may be mounted/arranged so as to optimize sound direction reception (e.g., of sound from signal source 30) and/or to optimize strength of the molding to head worn device 12. In other embodiments, microphones 18 and 20 may be built into various portions of the head worn device 12, e.g., the front, back, sides, top, bottom, etc., of the head worn device 12, to optimize sound detection from a variety of directions. In some embodiments, microphones 18 and 20 may be omnidirectional/non-directional, so as to detect sound in all directions. In other embodiments, the microphones 18 and 20 may be directional, so as to detect sound in a particular direction relative to the head worn device 12.

In some embodiments, user interface 56 and/or display 22 may be a superimposed/augmented reality (AR) overlay, which may be configured such that user 14 of head worn device 12 may see through transparent lens 16, and images/icons displayed on display 22 appear to user 14 of head worn device 12 as superimposed on the transparent/translucent field of view (FOV) through lens 16. In some embodiments, display 22 may be separate from lens 16. Display 22 may be implemented using a variety of techniques known in the art, such as a liquid crystal display built into lens 16, an optical head-mounted display built into head worn device 12, a retinal scan display built into head worn device 12, etc.

In some embodiments, gaze tracker 50 may track user 14's gaze and/or eye movements using a variety of techniques known in the art. In some embodiments, gaze tracker 50 may direct light (e.g., infrared/near-infrared light(s) emitted by light emitter 36) into user 14's eyes (e.g., into the iris and/or cornea). The emitted light may reflect and produce a “glint” on each eye cornea surface, and the position of each glint may be detected, e.g., using image sensor 38, which may be configured to filter the detected light (e.g., so that only the infrared/near-infrared light is detected). Gaze tracker 50 may detect (e.g., using image sensor 38) a point on each of user 14's eyes corresponding to the center of the pupil in each eye. Gaze tracker 50 may calculate the relative movement/distance between the pupil center and the glint position for each eye. For example, gaze tracker 50 may calculate an optical axis, which is a vector connecting the pupil center, cornea center, and eyeball center. Gaze tracker 50 may calculate a visual axis, which is a vector connecting the fovea and the center of the cornea. The visual axis and the optical axis may intersect at the cornea center (also referred to as the nodal point of the eye). Gaze tracker 50 may utilize preconfigured/estimated physiological data (e.g., stored in memory 46) regarding eye dimensions (e.g., cornea curvature, eye diameter, distance between pupil center and cornea center, etc.) which may be based on the demographic information of user 14 (e.g., male users and female users may have different average/estimated eye dimensions), to estimate the direction and angle of the optical axis. The angle of intersection of the glint vector and the pupil center vector may be used to estimate the angle between the optical axis and visual axis. Using the estimated optical axis, the estimated angle of intersection, and/or the preconfigured/estimated physiological information, gaze tracker 50 may estimate the visual axis, which corresponds to the user's estimated gaze.

In some embodiments, gaze tracker 50 may utilize a regression and/or machine learning model to estimate the gaze direction of user 14. For example, gaze tracker 50 (e.g., using image sensor 38), may detect physical/geometric features of user 14's face/head/eyes, and may use a machine learning model to determine the gaze direction based on the detected features.

In some embodiments, gaze tracker 50 may be configured to perform a calibration procedure. For example, user 14 of head worn device 12 may initiate a calibration procedure, e.g., upon first use of the device. The calibration procedure may include, for example, displaying reference points on display 22, instructing (e.g., using visual and/or audio commands via user interface 56) the user 14 to direct his gaze at the reference points, and adjusting one or more parameters utilized by gaze tracker 50 based thereon. Other calibration procedures may be used to improve the accuracy of gaze tracker 50, such as using machine learning (e.g., based on datasets of multiple users of head worn device 12), without deviating from the scope of the present disclosure.

Gaze tracker 50 may use any technique known in the art for determining/estimating the gaze of user 14 without deviating from the scope of the invention.

Sound locator 52 may determine the location, relative direction and/or relative distance of signal source 30 to user 14 using a variety of techniques known in the art. In some embodiments, sound locator 52 may apply a head related transfer function (HRTF) to the signals received by microphones, 18, which may be used to determine the left/right/horizontal orientation of the signal source relative to user 14. Sound locator 52 apply a HRTF to the signals received by microphones 20, compare the HRTF result for microphones 20 with the HRTF result of the microphones 18, and based on the comparison, determine an up/down/vertical orientation of the signal source 30 relative to user 14. Sound locator 52 may be configured to determine a vector from a suitable point, such as the bridge of user 14's nose, through the center of the plane formed by the four points corresponding to the locations of microphones 18 and microphones 20; this vector may point to the origin of signal source 30.

In some embodiments, sound locator 52 may additionally or alternatively utilize image data, e.g., from image sensor 38 and/or from hand held device 31, corresponding to the visual environment of user 14, to locate signal source 30, e.g., using edge detection, boundary tracing, machine learning techniques, etc. Sound locator 52 may also utilize radio signal data, e.g., from antenna array 60 of hand-held device 31, as an alternative to or in addition to using sound data, in estimating the location of signal source 30, as described herein.

Sound locator 52 may use any technique known in the art for determining/estimating the location of signal source 30 without deviating from the scope of the invention.

In some embodiments, sound classifier 54, based on the sounds detected by microphones 18 and/or 20, may estimate/predict/determine the type/label/class/cause of a sound originating from signal source 30, for example, determining a sound to be characteristic of events such as wood breaking, a person shouting/breathing, a person down alarm, a pressurized gas release (e.g., a jet release), etc. For example, in some embodiments, sound classifier 54 may utilize a library of sounds/sound markers to classify signal sources, e.g., by applying regression/machine learning techniques to a preconfigured dataset/library of labeled sounds/sound markers (e.g., stored in memory 46), generating a model for predicting/classifying detected sounds, and classifying a particular detected sound using the model. Other noise classification techniques known in the art may be used without deviating from the scope of the present disclosure.

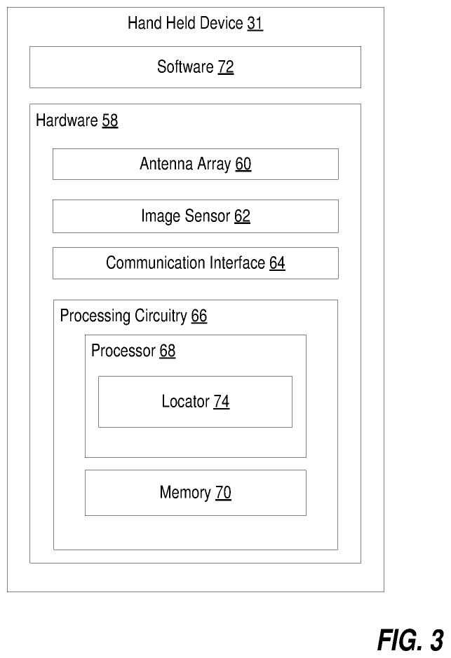

Referring now to FIG. 3, hand held device 31 may include hardware 58, including, antenna array 60, image sensor 62, communication interface 64, and processing circuitry 66. The processing circuitry 66 may include a processor 68 and a memory 70. In addition to, or instead of a processor, such as a central processing unit, and memory, the processing circuitry 66 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 68 may be configured to access (e.g., write to and/or read from) the memory 70, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Hand held device 31 may further include software 72 stored internally in, for example, memory 70 or stored in external memory (e.g., database, storage array, network storage device, etc.) accessible by hand held device 31 via an external connection. The software 72 may be executable by the processing circuitry 66. The processing circuitry 66 may be configured to control any of the methods and/or processes described herein and/or to cause such methods, and/or processes to be performed, e.g., by hand held device 31. Processor 68 corresponds to one or more processors 68 for performing hand held device 31 functions described herein. The memory 70 is configured to store data, programmatic software code and/or other information described herein. In some embodiments, the software 72 may include instructions that, when executed by the processor 68 and/or processing circuitry 66, causes the processor 68 and/or processing circuitry 66 to perform the processes described herein with respect to hand held device 31. For example, hand held device 31 may include locator 74 configured to perform one or more hand held device 31 functions as described herein such as determining the location/origin of a signal source 30, as described herein.

Antenna array 60 may be implemented by any device, either standalone or part of hand held device 31, that is configurable for detecting beacon signals from a radio beacon, e.g., a radio beacon emitted by an alarm device attached to the equipment of a downed first responder. Antenna array 60 may include one or more directional antennas used to follow a radio beacon.

Image sensor 62 may be implemented by any device, either standalone or part of hand held device 31, that is configurable for detecting images, such as thermal images, and/or configurable for detecting light inside the visible spectrum and/or outside the visible spectrum.

Communication interface 64 may include a radio interface configured to set up and maintain a wireless connection (e.g., with a remote server via a public land mobile network, with a head worn device 12 via a Bluetooth connection, etc.). The radio interface may be formed as, or may include, for example, one or more radio frequency, RF transmitters, one or more RF receivers, and/or one or more RF transceivers. Communication interface 64 may include a wired interface configured to set up and maintain a wired connection (e.g., an ethernet connection, universal serial bus connection, etc.). In some embodiments, hand held device 31 may send and/or receive, via the communication interface 64, sensor readings and/or data (e.g., image data, direction data, radio beacon data, etc.) from one or more of antenna array 60 and image sensor 62, to head worn device 12 and/or to remote servers (e.g., an incident command server, not shown). In some embodiments, sound locator 52 may utilize such sensor/image data in determining the location of signal source 30.

In some embodiments, head worn device 12 (e.g., using gaze tracker 50), may monitor the function of the irises of user 14's eyes as a metric for focus. Head worn device 12 may include one or more microphones (e.g., microphones 18 and microphones 20). In some embodiments, the microphones 18 and/or 20 may be mounted on either side, and/or on the front and/or back of the head worn device 12. In some embodiments, the microphones 18 and/or 20 may be pointed/directed so that sound is detected from the front of the head worn device 12. In other embodiments, the microphones 18 and/or 20 may be placed on the body of the user 14 and/or on other locations on the user 14's head. In some embodiments, microphones 18 and/or 20 may be placed and/or directed to the sides and rear of the user 14, e.g., to provide directionality to sound. In some embodiments, microphones 18 and/or 20 may be secured to head worn device 12 by mountings (not shown) molded into mask body 15 of head worn device 12, e.g., around a top portion of lens 16.

In some embodiments, sound classifier 54 may compare detected sounds (e.g., from microphones 18 and/or 20) to a library of sounds/sound markers characteristic of events such as wood breaking, a person shouting or breathing, a pressurized gas release like a jet release, a person down alarm, etc.

In some embodiments, head worn device 12 may be a respirator facepiece, goggles, a visor, and/or spectacles, and/or may be part of a self-contained breathing apparatus (SCBA).

In some embodiments, microphones 18 and/or 20 may provide sound cues (e.g., by detecting alarms, a voice, other audio, etc.). Head worn device 12, e.g., using sound locator 52, may apply the HRTF algorithm, and determines an approximate location of signal source 30 in 3-dimensional (x-y-z) space. In some embodiments, the determined approximate location may appear on display 22 as an icon of the image of the area in front of user 14 (e.g., in user 14's field of vision). In the case where signal source 30 is outside of display 22 (e.g., outside of user 14's field of view), an arrow or other icon may appear in the visual space (e.g., in user 14's field of view) showing user 14 where to look. In some embodiments, user interface 56 may utilize accelerometer 34 to adjust the indications as the user 14 moves throughout the environment. For example, accelerometer 34 may be configured to sense movement of user 14's body and/or head, e.g., sensing that user 14 has moved his head to face signal source 30.

In some embodiments, once user 14 is looking/gazing in the general vicinity of signal source 30, the head worn device 12 (e.g., using gaze tracker 50) may monitor the eyes of user 14 for visual cues as to whether user 14 is looking in the right place (e.g., in the direction of the determined approximate location of signal source 30). In some embodiments, display 22 may display a virtual series of concentric boxes with location icons that may indicate the location (e.g., as determined by sound locator 52 using the HRTF function) and/or may indicate an icon representing the focal location/gaze direction of user 14's eyes. As user 14 proceeds toward the location of signal source 30, display 22 may continually/periodically refresh, providing updated cues to user 14 regarding the location of signal source 30, until the location is reached and/or until user 14 terminates the procedure (e.g., by a voice command or toggling a button).

In some embodiments, user 14 may activate/deactivate the search procedure by a voice command (e.g., via microphone 28 and/or user interface 56) and/or by toggling a switch/button (e.g., in communication with user interface 56). In some embodiments, one or more components of head worn device 12, such as gaze tracker 50, sound locator 52, sound classifier 54, and/or user interface 56, may be located in/performed by separate circuitry located elsewhere on user 14's body, such as in a hand held device 31 or remote in communication with head worn device 12, e.g., via a wired or wireless connection with communication interface 40.

In some embodiments, sound locator 52 may be configured to perform a calibration procedure, e.g., upon user 14's first use of head worn device 12. In some embodiments, the calibration procedure is configured to compensate for any head and/or hearing protection worn by user 14, which may impact the directionality of sound.

In some embodiments, sound locator 52 may be configured to utilize thermal imaging and/or other visual data (e.g., received from image sensor 38 and/or from other image sensors, such as an image sensor 62 in a separate hand held device 31 in communication with head worn device 12 via communication interface 40) in determining the location of signal source 30. Such visual data may include images of light outside the visible spectrum.

In some embodiments, hand held device 31 in communication with head worn device 12 is configured to follow a radio beacon, e.g., using antenna array 60. Hand held device 31 is configured to be swept back and forth, up and down, etc., by user 14, to try to identify the maximum beacon strength, e.g., by comparing measurements of signal strength detected by antenna array 60. In some embodiments, hand held device 31 may determine the radio beacon's direction by taking multiple directional measurements (e.g., with antenna array 60), which may result in a virtual conical structure as the user 14 approaches the source of the beacon. The locator 74 may be configured to identify the part of the conic segmented detected and calculate it backward to identify the apex of the cone, which represents the location of signal source 30. For example, signal source 30 may be a personal alert/distress alarm device (e.g., a Scott Pak-Alert Personal Alert Safety System (PASS) device), worn by a downed first responder, which may give off an audible sound (e.g., a piercing sound) and/or may emit a radio signal/beacon when activated. Detecting a radio signal in addition to/as an alternative to a detecting a sound signal may be advantageous, for example, in scenarios where detecting an audible sound signal is impractical, such as where a downed first responder is at least partially submerged underwater, where the personal alert device's sound chambers have been occluded by debris, due to environmental conditions, etc. Detecting a radio signal in addition to detecting a sound signal may thus improve the accuracy of estimating the location/direction of signal source 30.

In some embodiments of the present disclosure, the hand held device 31 and/or head worn device 12 may be configured to determine the location of the personal alert device based on characteristics of the audible sound signal and/or the emitted radio signal, and the head worn device 12 may be configured to determine whether the user 14 is looking and/or facing in the direction of the location of the personal alert device and/or may be configured to direct the user 14 to the location of the signal source 30, even in scenarios where the audible sound signal cannot be detected and/or where visibility is at least partially blocked.

Locator 74 may detect signals (e.g., sound signals/waves, radio signals/waves, etc.) at multiple various points throughout the environment (i.e., 3-dimensional space) and record characteristics of those signals, such as signal strength, power, amplitude, frequency, noise, etc. Locator 74 may construct/utilize a 3-dimensional model based on the detected signals to determine/estimate the origin of the signal source 30 and/or to guide user 14 to the signal source 30. As one non-limiting example, the signal may be modeled as a 3-dimensional cone, and locator 74 may utilize one or more formulas known in the art, such as the equation for the curved surface of a right cone, to determine one or more characteristics of the signal. The hand held device 31 may detect signals as the user 14 moves through the environment, and/or user 14 may intentionally move the hand held device (e.g., in a sweeping motion) in order to gather detected signal data points at various locations relative to user 14.

For example, a downed first responder's personal alert device (i.e., a signal source 30) may emit a sound signal and/or a radio signal/beacon, which may be represented as a spherical field in 3-dimensional space. Within the field, there may be layers of constant field strength, which may be represented as concentric spheres (i.e., a radio energy sphere). The hand held device 31 may include a large directional antenna (e.g., as part of antenna array 60) and may also include a display/indicator to indicate signal strength to user 14, and/or may provide such information to user 14 via the head worn device 12 (e.g., display 22 and/or speaker 26). The hand held device 31 may be configured to sample one or more points in 3-dimensional space, as user 14 moves throughout the environment, to generate/estimate the shape of the signal (e.g., a virtual cone) and/or to predict the origin of the signal (i.e., signal source 30). Hand held device 31 may be configured to capture the detected signal data (e.g., signal strength) and position/location data, and determine the shape of the sound and/or radio signal (e.g., a cone) and/or the source of the signal (signal source 30), and may provide the data to the user, e.g., as a translucent conical shape overlayed in display 22 of head worn device 12, to assist with guiding the user 14 towards signal source 30.

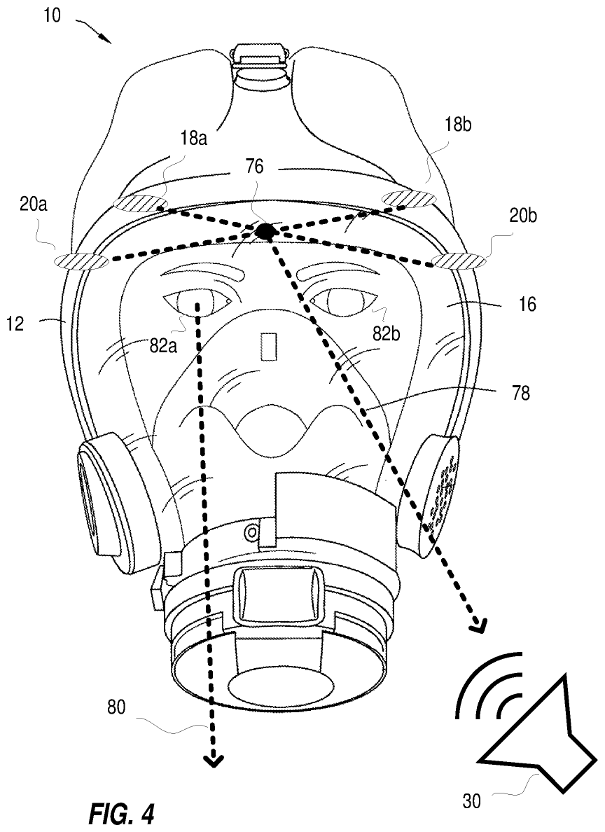

FIG. 4 depicts an example scenario according to some embodiments of the present disclosure. In this scenario, user 14 is looking directly ahead at the time that the detected sound from signal source 30 is detected at an angle downward and to user 14's left. For example, head worn device 12 and/or sound locator 52 may apply a head related transfer function (HRTF) based on the characteristics of audio signals received from microphones 18 and/or 20, to determine an HRTF focal point 76 and a vector 78 from focal point 76 to signal source 30. In some embodiments, such directional measurements may be an approximation used to direct the user 14 closer to the target (e.g., signal source 30). As user 14 approaches the target, the quality of the measurements may improve. For example, gaze tracker 50 may determine that user 14 may be directing his gaze directly ahead, e.g., as represented by vector 80 from eye 82a (and/or eye 82b) in the direction of gaze. For example, a vector 80 may be projected from the cornea of eye 82a to the back of eye 82a, and the average diameter of eye 82a may be a known/predetermined value, e.g., based on population averages and/or demographic information (e.g., of user 14). The back of eyes 82a-b are fixed to allow the optic nerve to pass through the skull. The vector 80 may be determined based on detecting the location of the iris and/or cornea of eye 82a and/or eye 82b, for example, using infrared radiation emitted from light emitter(s) 36, which may be used by gaze tracker 50 to determine vector 80. Using lens 16, which may be part of a facepiece of head worn device 12, as a plane, and adjusting for the depth and/or curvature differences using known geometric relations, two vectors may be determined on a common base, which may allow for the application of Euclid's parallel postulate. In particular, if the interior angles of the two lines sum up to 180 degrees or less, they are parallel or converging. The particular geometric formulas to be applied are known in the art and beyond the scope of the present disclosure. An in mask indicator (e.g., user interface 56 and/or display 22) may display to the user an arrow, concentric circle display, or other directions/icons to instruct the user 14 to adjust the user 14's gaze.

Direction of user 14's gaze, e.g., as determined by gaze tracker 50, may include the direction user 14's face is pointed and/or the direction user 14's eyes are pointed. A variety of eye tracking techniques known in the art may be employed by gaze tracker 50. Eye tracking relates to locating a fixed point on the surface of user 14's eye and monitoring the motion of the fixed point. A variety of gaze tracking techniques known in the art may be employed by gaze tracker 50.

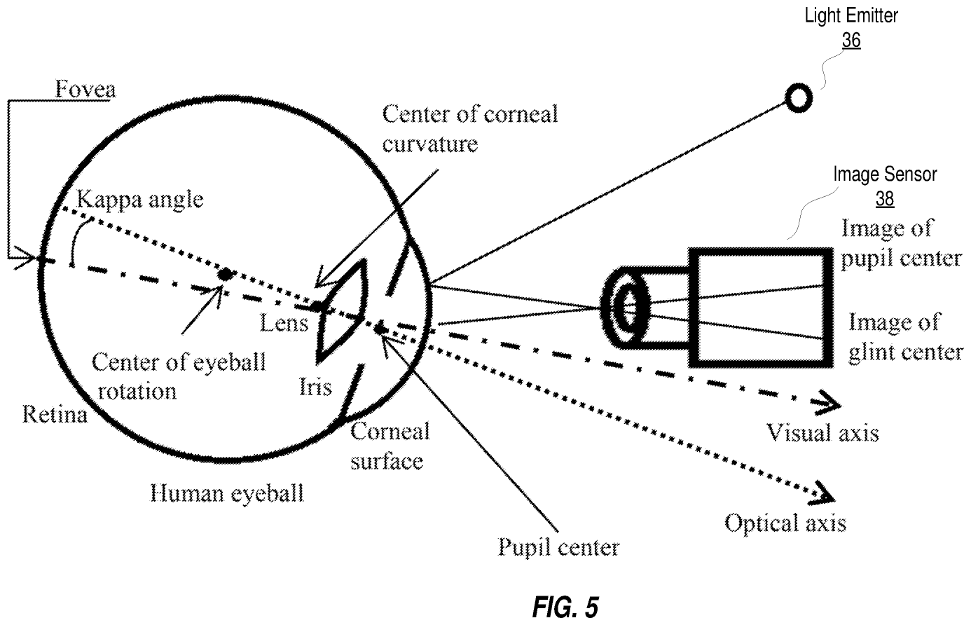

As illustrated in FIG. 5, gaze tracking or gaze direction determination techniques may utilize the commonality in eye physiology, musculature, orbit, geometry, etc., in human populations to fix a point and then eye track the pupil to locate the second point. The two points may define a line/vector which may be defined by an equation. There are a variety of techniques known in the art to determine such a vector. For example, the first point may be a center of the eye's pupil, and the second point may be a light reflection on the cornea, e.g., a reflection of the light emitted by light emitter 36 and captured by image sensor 38. The visual axis, which may correspond to user 14's gaze, may be estimated by determining the kappa angle (i.e., the angle between the optical axis and the visual axis with the corneal surface as the vertex), e.g., based on a calibration of user 14's eyes 82a-b.

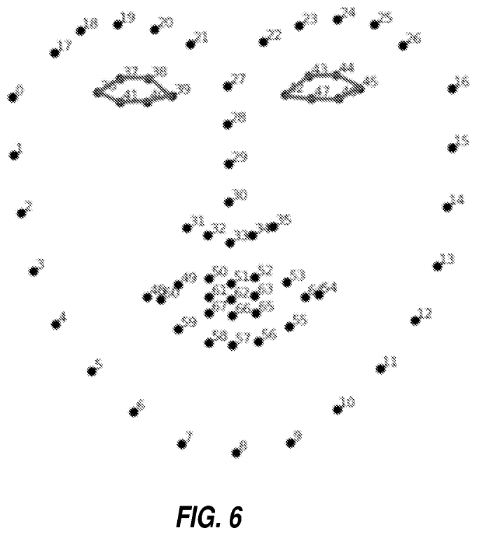

In some embodiments, gaze tracker 50 may perform eye detection and/or gaze mapping. A feature based mapping may be employed, e.g., using a 2-dimensional model (support vector regression, neural networks, etc.) or a 3-dimensional model. A landmark-based method is illustrated in FIG. 6, which sets the coordinates and/or points, e.g., in a .dat file. These features may utilize datasets and/or machine learning techniques known in the art to map facial features to predicted gaze direction(s). In some embodiments, application specific datasets may be generated while a user 14 wears head worn device 12. Eye/face/image/location data associated with user 14 may be stored, e.g., in head worn device 12, and may be used to generate/refine a machine learning model, improving the accuracy of prediction over time as more data is collected. Additionally, or alternatively, head worn device 12 may use synthetic datasets, e.g., with large participant sources. Such datasets may include infrared image samples of participants' faces and/or eyes. Using datasets/machine learning enables the gaze tracker 50 to adapt/tune/calibrate to a wide variety of users 14. In some non-limiting embodiments, gaze tracker 50 may utilize a variety of computer vision libraries, such as Python OpenCV. While gaze tracker 50 can be implemented using any suitable hardware and/or software arrangement, some embodiments may utilize/execute software code written in C++ as well as Python, making it more adaptable to being deployed on a variety of microcontrollers.

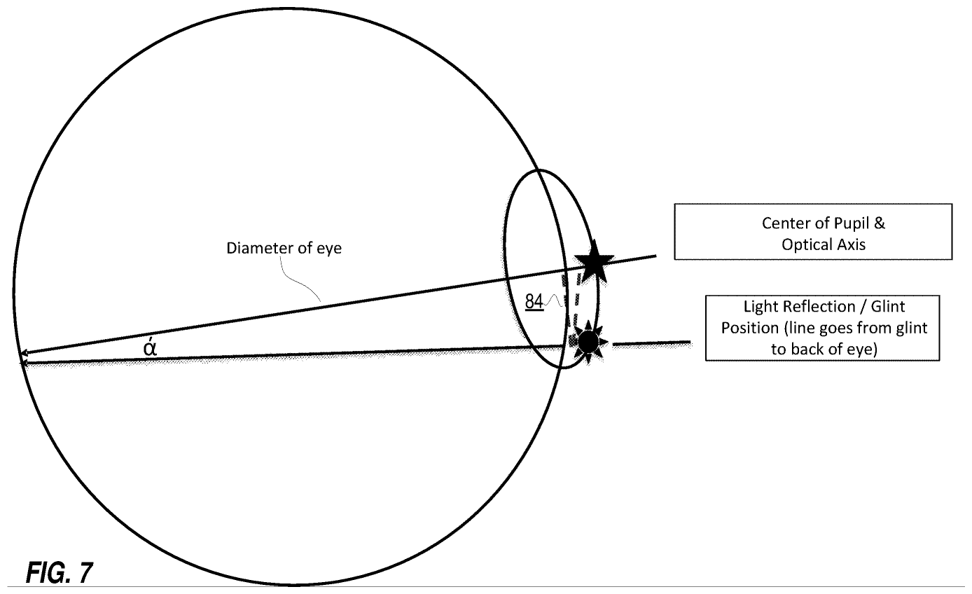

In some embodiments, gaze tracker 50 is configured to estimate the gaze of user 14, as illustrated in FIG. 7. In these embodiments, the diameter of eye 82a (or 82b) is a known and/or estimated value. The estimate may be based on population averages, demographic information of user 14, and/or machine learning techniques. The distance between the line representing the diameter of the eye and the line representing the light reflection may be measured, e.g., using image sensor 38. Using known geometric formulas and relations, the specific details of which are beyond the scope of the present disclosure, the angle between the center of the eye and the glint, as well as the characteristics light reflection line and the optical axis, may be determined. For example, as the ray from the light reflection (e.g., of light emitted by light emitter 36) approaches the ray from the center of the pupil, the right triangle formed becomes a single triangle, rather than two triangles back-to-back. Given the approximate eye diameter (or base of the triangle), the altitude leg of the triangle may be measured (e.g., using image sensor 38). For example, the altitude of the triangle may be taken as the distance of the line representing the diameter of the eye from the surface of the cornea to the back of the eyeball, and the hypotenuse of the triangle may be taken as the distance from the surface of the cornea at the glint to the back of the eyeball. A straight line from the glint on the cornea to the line representing the diameter of the eye forms the third leg of the triangle.

These techniques may be improved using machine/neural network learning. For example, a neural network may be initially trained using publicly available datasets, and may be further trained/refined for a particular group of users 14 (e.g., employees of a particular firefighting service) by gathering data from actual use and/or from an artificial training/calibration scenario, e.g., by setting up a sound target to emulate signal source 30, and instructing a user 14 to go through a pattern of movements, such as a facepiece fit sequence. During actual use and/or training/calibration use, the head worn device 12 may gather data (e.g., images of the user 14's eyes, face, environment, signal/location data of signal source 30, etc.) to train the neural network.

For example, as illustrated in FIG. 7, when the light reflection ray and the ray from the center of the pupil are close enough, a right triangle 84 is formed, with no smaller right triangle to the right of triangle 84. The tangent, \acute{α}, is equal to the ratio of the opposite side to the adjacent side, which is equal to slope, b, of the light reflection ray. The equation of the line for light reflection is of the form y=mx+b, and thus y=(tan \acute{α})x. This analysis may be iteratively repeated in a circle to perfect the equation in three-dimensional space. The multiple lines may be tested to select the best fit and avoid polar coordinates. By using multiple image sensors 38, head worn device 12 may determine the glint/optical axis from multiple perspectives, which may improve the accuracy of the estimation.

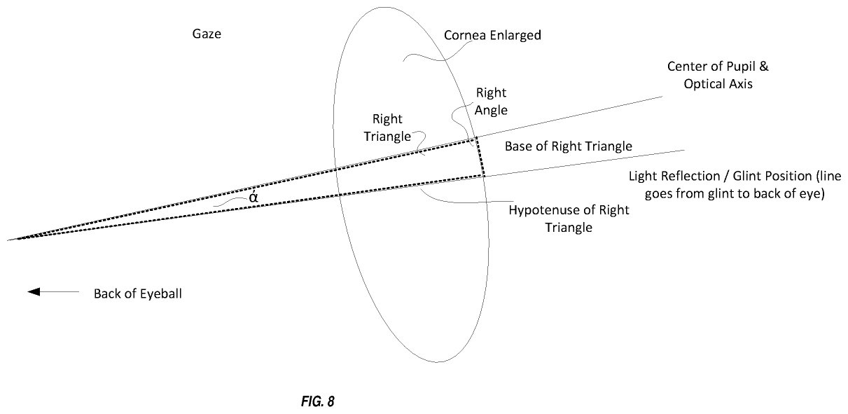

To further illustrate, as shown in FIG. 8, as the ray from the light reflection approaches the ray from the optical axis of the pupil, the base of the right triangle gets smaller and the angle \acute{α} gets smaller. If user 14 is not looking directly at the origin of the glint, there will be a measurable length to the base of the triangle. If the user 14 is looking directly at the origin of the glint, the length of the base will approach zero. A right triangle may be determined using known geometric formulas/relations, the details of which are beyond the scope of the present disclosure. The line defined as the optical axis may be compared to the line calculated from the HRTF (i.e., the direction of signal source 30). The slopes of the two lines should be equivalent when the user 14 is looking in the direction of signal source 30. The base of the triangle may be fixed and representative of the distance from the optical axis and the HRTF line just inside the lens 16. To adjust the slope, the head worn device 12 may instruct the user to look in the direction that minimizes the difference in slopes and/or causes the difference to approach zero. A trial and error approach may be used to determine how far user 14 must move his gaze and in which direction to minimize the different in slopes. This process may be iteratively repeated, e.g., using multiple image sensors 38 and multiple microphones 18 and 20 to improve the accuracy of the model, select the best fit, etc.

In some embodiments, gaze tracker 50 determines a gaze direction based on two components: the direction the eyes are pointed and the direction the face is pointed. In some embodiments, gaze tracker 50 employs/considers/compensates for the Wollaston Effect, the Mona Lisa Effect, and/or the Mirror Effect. The particular techniques for compensating for these effects are known in the art and beyond the scope of the present disclosure.

In some embodiments, sound locator 52 utilizes a HRTF. A HRTF is a measure of the difference of hearing between the listener's (e.g., user 14) right and left ears. Placing the microphones 18 and/or 20 on either side of the facepiece, sound locator 52 may simulate a simplified head-form hearing system without needing to account for pinna structure, ear internal inefficiencies, etc. The HRTF may consider two signal collection points separated by a space and use that information to determine/estimate a signal origin location. Utilizing two pairs of microphones 18 and/or 20 may further improve accuracy and/or may provide additional information, such as how user 14's head is tilted and/or pointed with respect to signal source 30. The particular formulas utilized for the HRTF are known in the art and beyond the scope of the present disclosure.

Because the head worn device 12 with microphones is not actually a human head with ears, the signal source estimation may be simplified for the head worn device 12 with microphones 18 and 20. In particular, based on the HRTF formulas, the head worn device 12 may determine that the user 14 is facing the signal source. In some embodiments, the user 14's face may be calibrated using a simplified transfer function. For example, a tight-fitting head worn device 12 may have a different transfer function as compared to a loose-fitting head worn device 12.

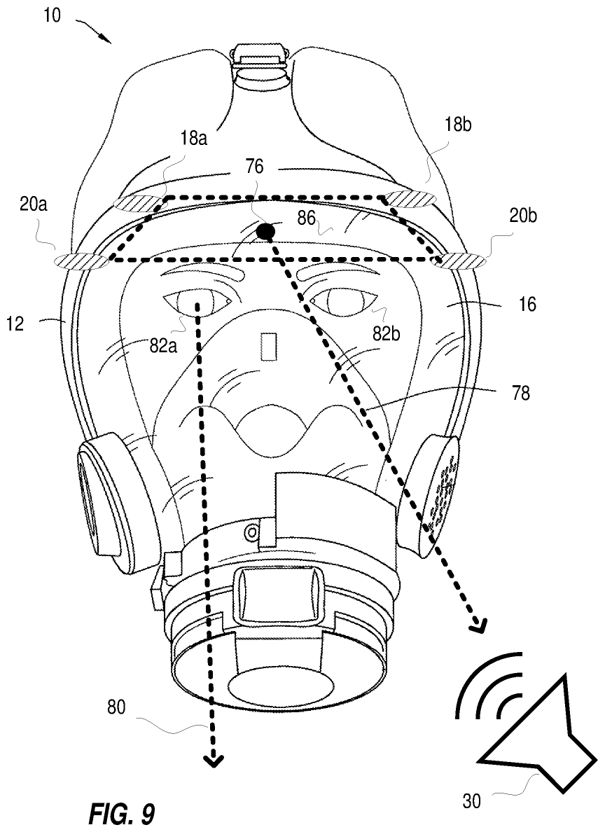

In some embodiments, head worn device 12 may include two or more sets of microphones, e.g., microphones 18 and 20. Sound locator 52 may apply a transfer function to the top two microphones 18 to derive a left-right orientation. Sound locator 52 may apply a transfer function to the bottom two microphones 20, compare to the upper two microphones 18, and derive an up-down orientation therefrom For example, if the two microphones 18a and 20a on the left side of user 14's head detect a comparable sound intensity that is higher than the two microphones 18b and 20b on the right side of user 14's head, it may be predicted that the signal source 30 is to user 14's left. Similarly, if the top two microphones 18 have a comparable sound intensity that is higher than the two lower microphones 20, then the inference is that the signal source is above user 14. Once microphones 18 and 20 are balanced (i.e., the detected sound signals are of similar amplitude, intensity, etc.), sound locator 52 may determine the direction of signal source 30 relative to user 14. In some embodiments, as illustrated in FIG. 9, microphones 18 and 20 may be arranged on head worn device 12 such that the center of a plane 86 formed by the microphone 18 and 20 locations is in the general location of the bridge of user 14's nose. Sound locator 52 may calculate a line (e.g., of the form y=mx+b) running from the bridge of the nose through the focal point 76 of plane 86, which line may be determined to be the source 30 of the sound. Geometric relations/formulas as shown in FIG. 7, the details of which are well known in the art and beyond the scope of the present disclosure, may be used to estimate the line. The geometric position of plane 86 may be defined by the microphones 18 and 20. The location of the bridge of the nose cup may be the other point defining the line, which points to the direction of signal source 30.

In some embodiments, a first line is formed by the direction of user 14's gaze (e.g., as determined by gaze tracker 50) and a second line is formed by the direction the user is facing (e.g., as determined by gaze tracker 50). If the two lines are coincident (i.e., y1=mx1 and y2=mx2, such that x1=x2), then gaze tracker 50 may determine that user 14 is looking at signal source 30. If the two line do not meet this condition, then, using a comparative algorithm, user interface 56 may notify user 14 to adjust the direction of user 14's face. The degree of adjustment may follow a trial and error algorithm, with the process halting once the iterations of slope change less than a threshold value (e.g., 10%) after multiple trials, for example. Alternatively, a 2-dimensional or 3-dimensional least squares algorithm, or other various geometry calculations known in the art, the particular details of which are beyond the scope of the present disclosure, may be employed to iteratively improve the accuracy. The ability of user 14 to adjust accurately can be assisted by providing a display 22 attached to an accelerometer 34, as well as a representation in display 22 (e.g., as an AR overlay) of the two lines in the distance. Using this display 22, user 14 may adjust his gaze to the direction of signal source 30. In some cases, the two lines may not be coincident or at least parallel. For example, user 14 may have his face pointed in the correct direction of signal source 30, but may be gazing up, down, right, or left of signal source 30. As another example, user 14 may be confused as to the source of sound, and may be facing the wrong direction altogether. As another example, head worn device 12 may be detecting an echo or a sound reflection. Sound locator 52 may be configured to compensate for sound reflections. For example, sound locator 52 may consider the amplitude of the sound will change after the reflection, but the frequency will not change. Sound locator 52 may utilize additional microphones (e.g., installed on the sides/back of head worn device 12), compare the amplitudes and/or frequencies of the sounds received from the side/back microphone with that received from the front microphones (18 and 20), and determine whether the front microphones 18 and 20 are detecting a sound or an echo of a sound. If the lines share a common slope, and direction, then sound locator 52 may determine that user 14 is looking in the general vicinity of the source of the sound. Sound locator 52 may utilize vertical angles and auxiliary lines to further analyze the lines, according to geometric formulas known in the art which are beyond the scope of the present disclosure.

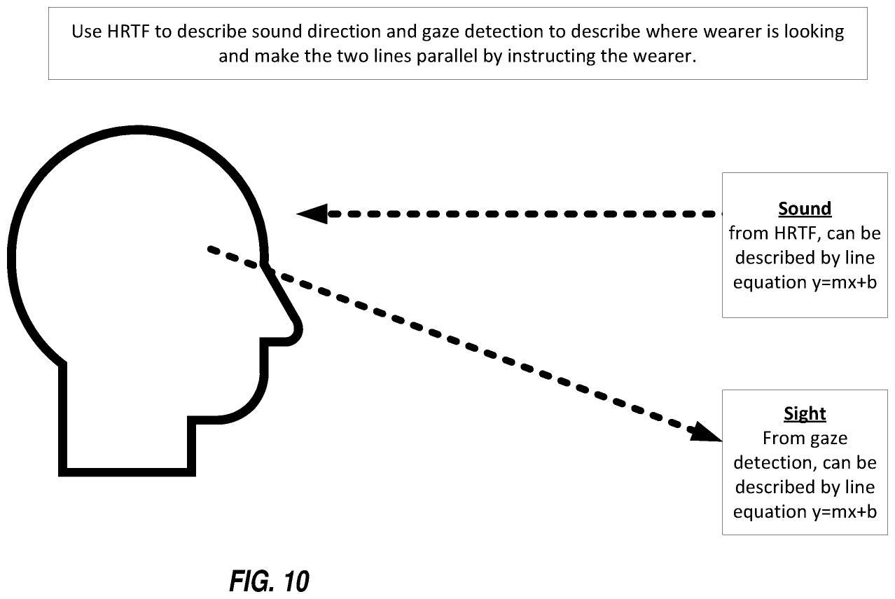

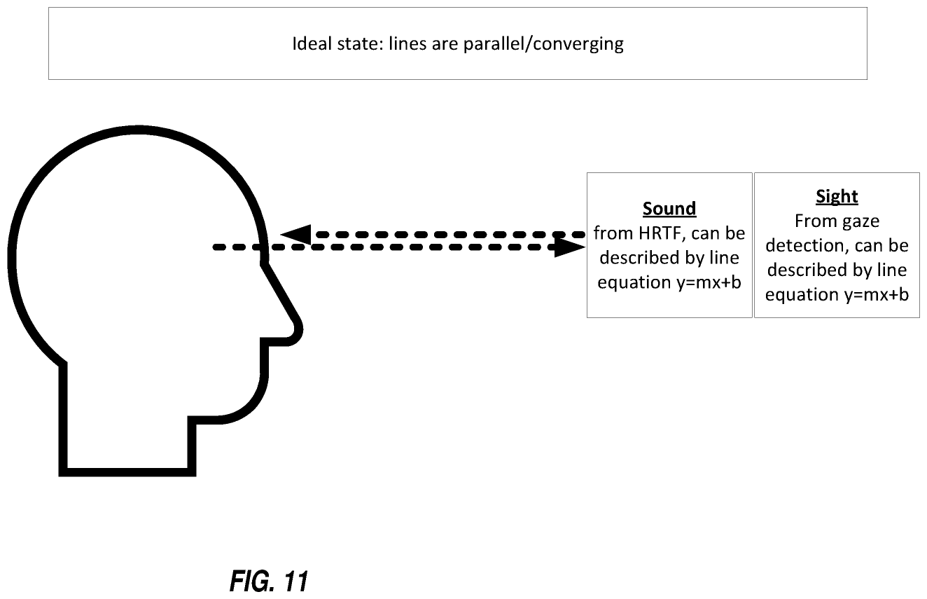

FIGS. 10 and 11 illustrate another example of using HRTF to determine sound direction and gaze detection. The sound direction (from signal source 30) may be modeled as a straight line. The gaze direction may be modeled as a straight line as well. The head worn device 12 uses HRTF to describe/determine the sound direction/origin and the direction the user 14 is looking, and instructs the user 14 to change gaze direction in order to make the two lines parallel/converging, and this condition is indicative of the user 14 gazing in the direction of signal source 30.

In some cases, there may be multiple estimates of the location of signal source 30, e.g., a point behind the user 14 and a point in front of user 14. Head worn device 12 may provide user 14 (e.g., via display 22) with multiple estimates of the location of signal source 30, e.g., by displaying multiple vectors overlayed on display 22, and user 14 may determine which vector to follow, for example, user 14 may have just passed through a room and did not find the signal source 30 in that room, and user 14 may use that information to decide to ignore a vector on display 22 pointing user 14 back to that room, and instead will follow a vector pointing to a new room which user 14 has not previously entered.

In some embodiments, multiple head worn devices 12 associated with multiple users 14 may cooperate (e.g., by wireless transmitting data directly or indirectly with one another, by communicating with a remote server, etc.) to improve the accuracy of the estimated location of signal source 30. For example, if multiple users 14 in a first responder team are present at an emergency scene, each equipped with a corresponding head worn device 12, the detected signals (e.g., sounds waves) from each head worn device 12 may be distributed to the other head worn devices 12 of the first responder team, each of which may utilize the additional data to improve the accuracy of the signal source 30 location detection. Similarly, one or more users 14 in the first responder team may be equipped with hand held devices 31, which may detect radio signals emitted by signal source 30, as described herein, and the head worn devices 12 may utilize the location information generated by one or more of the multiple hand held devices 31 (e.g., as determined by locators 74). As another example, if one head worn device 12 locates signal source 30, the location data (e.g., geographical coordinates, distance/angle information, etc.) may be shared with the other head worn devices 12 of the first responder team.

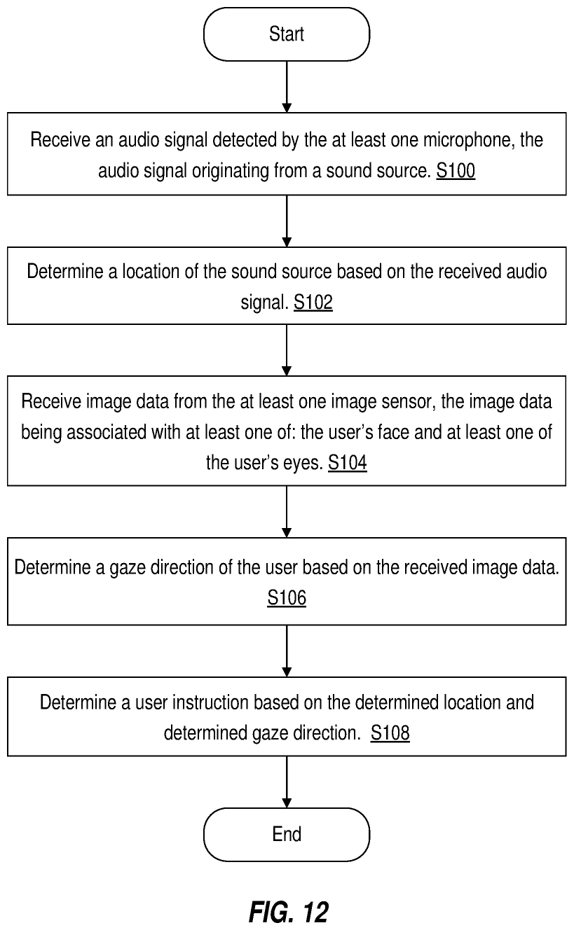

FIG. 12 is a flowchart of an example process in a head worn device 12 according to some embodiments of the invention. One or more blocks described herein may be performed by one or more elements of head worn device 12, such as by one or more of processing circuitry 42, microphones 18, microphones 20, display 22, speaker 26, microphone 28, accelerometer 34, light emitter 36, image sensor 38, communication interface 40, processing circuitry 42, processor 44, memory 46, software 48, gaze tracker 50, sound locator 52, sound classifier 54, and/or user interface 56. Head worn device 12 is configured to receive (Block S100) an audio signal detected by at least one microphone (e.g., microphones 18 and microphones 20), the audio signal originating from a signal source 30. Head worn device 12 is configured to determine (Block S102) a location of the signal source 30 based on the received audio signal. Head worn device 12 is configured to receive (Block S104) image data from the at least one image sensor 38, the image data being associated with at least one of: user 14's face and at least one of user 14's eyes. Head worn device 12 is configured to determine (Block S106) a gaze direction of user 14 based on the received image data. Head worn device is configured to determine (Block S108) a user instruction based on the determined location and determined gaze direction.

In some embodiments, the user instruction is determined based on at least one of a relative distance and a relative direction from the user 14 to the signal source 30. In some embodiments, the user instruction indicates a location and/or direction for the user to look.

In some embodiments, the head worn device 12 includes at least one light emitter 36 in communication with the processing circuitry 42. In some embodiments., the least one light emitter 36 is configured to emit light into at least one of user 14's eyes to cause at least one reflection glint for use in determining the gaze direction.

In some embodiments, determining a gaze direction of the user 14 includes determining a plurality of features based on the image data using a machine learning model to predict gaze direction based on the determined plurality of features.

In some embodiments, the processing circuitry is further configured to receive, from the signal source, a radio signal, the determining the location of the signal source being further determined based on the received radio signal.

In some embodiments, the processing circuitry 42 is further configured to determine a plurality of features based on the received audio signal. In some embodiments, the processing circuitry is configured to determine a sound classification based on the determined plurality of features using a machine learning model to predict a sound classification of the signal source 30 based on the determined plurality of features.

In some embodiments, the head worn device 12 includes a user interface 56. In some embodiments, the user interface 56 is configured to display the user instruction as an augmented reality (AR) indication.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings.

1. A head worn device configured to be worn by a user, the head worn device including at least one microphone, at least one image sensor, and processing circuitry in communication with the at least one microphone and the at least one image sensor, the processing circuitry being configured to:
receive an audio signal detected by the at least one microphone, the audio signal originating from a signal source;
determine a location of the signal source based on the received audio signal;
receive image data from the at least one image sensor, the image data being associated with at least one of: the user's face and at least one of the user's eyes;
determine a gaze direction of the user based on the received image data;
determine a user instruction based on the determined location and determined gaze direction.

2. The head worn device of claim 1, wherein the user instruction is determined based on at least one of a relative distance and a relative direction from the user to the signal source.

3. The head worn device of claim 1, wherein the head worn device includes at least one light emitter in communication with the processing circuitry, the at least one light emitter configured to emit light into at least one of the user's eyes to cause at least one reflection glint for use in determining the gaze direction.

4. The head worn device of claim 1, wherein determining a gaze direction of the user includes determining a plurality of features based on the image data using a machine learning model to predict gaze direction based on the determined plurality of features.

5. The head worn device of claim 1, wherein the processing circuitry is further configured to receive, from the signal source, a radio signal, the determining the location of the signal source being further determined based on the received radio signal.

6. The head worn device of claim 1, wherein the processing circuitry is further configured to:
determine a plurality of features based on the received audio signal;
determine a sound classification based on the determined plurality of features using a machine learning model to predict sound classification of the signal source based on the determined plurality of features.

7. The head worn device of claim 1, wherein the head worn device includes a user interface, the user interface being configured to display the user instruction as an augmented reality (AR) indication.

8. A method, in a head worn device worn by a user, for directing the user to a location of a signal source in a limited visibility environment, the method comprising:
receiving, by processing circuitry from at least one microphone of the head worn device, an audio signal originating from the signal source;
determining, by the processing circuitry, a location of the signal source based on the received audio signal;
receiving, by the processing circuitry from at least one image sensor of the head worn device, image data associated with at least one of the user's face and at least one of the user's eyes; determining, by the processing circuitry, a gaze direction of the user based on the received image data; and
determining, by the processing circuitry, a user instruction based on the determined location and the determined gaze direction, wherein the user instruction is configured to indicate the location of the signal source to the user.

9. The method of claim 8, further comprising receiving, by the processing circuitry, a radio signal originating from the signal source, wherein determining the location of the signal source is further based on the received radio signal.

10. The method of claim 8, wherein determining the location of the signal source comprises applying, by the processing circuitry, a head related transfer function to the audio signal to estimate a direction from the user to the signal source.

11. The method of claim 10, further comprising comparing, by the processing circuitry, a first head related transfer function result from a pair of microphones and a second head related transfer function result from another pair of microphones; and determining, by the processing circuitry, a vertical orientation of the signal source relative to the user based on the comparison.

12. The method of claim 8, further comprising determining, by the processing circuitry, a set of features representative of the received audio signal; and determining, by the processing circuitry, a classification of the signal source based on the set of features.

13. The method of claim 8, wherein determining the user instruction comprises displaying, via a user interface of the head worn device, an indication directing the user to adjust gaze toward the location of the signal source.

14. The method of claim 8, further comprising emitting, by at least one light emitter of the head worn device, light into at least one of the user's eyes to cause at least one reflection glint; and including, by the processing circuitry, data associated with the reflection glint in the received image data for determining the gaze direction.

15. The method of claim 8, further comprising performing, by the processing circuitry, a calibration procedure by displaying at least one reference point on a display of the head worn device and instructing the user to visually focus on the reference point, the calibration procedure refining determination of the gaze direction.

16. The method of claim 8, further comprising generating, by a speaker of the head worn device, an audio message corresponding to the user instruction.

17. The method of claim 8, wherein receiving image data comprises detecting, by the at least one image sensor, infrared light reflected from at least one of the user's eyes.

18. The method of claim 8, further comprising receiving, by the processing circuitry, multiple audio signal measurements at different positions of the user, and estimating, by the processing circuitry, a relative distance to the signal source based on changes in the audio signal.

19. The method of claim 8, further comprising detecting, by an accelerometer of the head worn device, head movement of the user while the user moves; and updating, by the processing circuitry, the user instruction based on the detected head movement.

20. The method of claim 8, wherein the user instruction is displayed as an augmented reality overlay in a lens of the head worn device, the overlay indicating the location of the signal source within a field of view of the user.
